(19) United States
(12) Patent Application Publication
(10) Pub. No.: US 2009/0100872 A1
(43) Pub. Date: Apr. 23, 2009

(54) Method for laminating glass, glass-ceramic, or ceramic layers

(76) Inventors: Daniel Warren Hawtof, Corning, NY (US); Michael Yoshiya Nishimoto, Painted Post, NY (US); Huan-Hung Sheng, Horseheads, NY (US); Gary Graham Squier, Beaver Dams, NY (US)

Correspondence Address: CORNING INCORPORATED, SP-TI-3-1, CORNING, NY, 14831, US

(21) Appl. No.: 11/975,006

(22) Filed: Oct. 17, 2007

(51) Int. Cl. C03B 23/203

(52) U.S. Cl. 65/36

(57) ABSTRACT

A method for laminating glass, glass-ceramic, or ceramic layers. The method comprises providing a first layer of glass, glass-ceramic, or ceramic, wherein the glass, glass-ceramic, or ceramic of the first layer is electromagnetic radiation-sensitive or has an electromagnetic radiation susceptor disposed on it; stacking a second layer of glass, glass-ceramic, or ceramic on the first layer; and irradiating the stack with electromagnetic radiation to laminate the first and second layers.

### TECHNICAL FIELD

The invention relates to lamination of glass, glass-ceramic, or ceramic layers using electromagnetic radiation.

### BACKGROUND

Glass may be laminated to improve mechanical properties such as strength and shatter-resistance. Laminated glass finds utility as automotive and aircraft glazing, transparent armor, and other applications where glass must be strengthened and/or rendered shatter resistant.

Conventional glass laminates may include one or more glass layers and an interlayer comprising a polymer. The polymer often includes polyvinylbutyral (PVB) but may also comprise other suitable polymers such as polycarbonate, urethanes, epoxies, and acrylics. The glass lamination process typically includes sandwiching the polymer interlayer between a pair of glass layers. The sandwich is then evacuated to remove air and moisture, pressed, and heated. This process can involve extended times at elevated temperatures (80-140 C) and pressures (4-20 MPa). The laminate must then be cooled slowly to avoid cracking or stress concentrations. As a result, conventional laminating processes can be slow and require considerable capital expenditure to set up the necessary presses, vacuums, and autoclaves.

Recently, microwave radiation has been used to produce a glass laminate comprising a polymer interlayer between glass sheets. The radiation softens the polymer interlayer thereby bonding the glass sheets. The microwave radiation may be generated by a gyrotron, which advantageously produces high frequency microwaves in the form of a directable beam. A gyrotron's output may exceed one megawatt with output frequencies from about 20-300 GHz. These energies can produce a high heat flux (up to 15 kW per sq. cm.) at targeted portions of an object without significant heating of surrounding portions. Energy absorption is proportional to the microwave frequency, the material's permittivity, the loss factor of the material, and the square of the local electric field.

The gyrotron radiation method includes assembling a sandwich structure of at least two layers of glass separated by a polymer interlayer, subjecting the sandwich to a vacuum, pressing while simultaneously irradiating the sandwich, and cooling the sandwich to produce the glass laminate. The glass layers have a very low loss factor compared to the polymer interlayer; therefore, the glass absorbs very little energy. The polymer interlayer does absorb the radiation, and softens or melts thereby bonding the glass layers without substantially heating the glass layers. The gyrotron method promises decreased energy consumption and increased throughput. In this method, the polymer interlayer is essential to creating the laminate.

Problems exist with any laminating method that uses a polymer interlayer. The polymer is inherently weaker than the glass layers, is less resistant to heat, and can be prone to discoloration and various degrees of opacity. The polymer may also release volatile gases during heating that produce bubbling. Bubbling is a significant defect in transparent articles, and can reduce strength and cause delamination. Bubbling may be reduced by extending process times that enable entrapped gases to diffuse from the laminate or to dissolve back into the polymer film. Laminates comprising high surface areas or multiple laminates increase the time required for reducing bubbling.

Attempts have been made to reduce bubbling by increasing the space between glass layers, using a lower viscosity interlayer, varying the thickness of the interlayer, forcing a resin into the interlayer through a one-way valve, and pressing in a vacuum, but none are fully effective. Further, polymer interlayers can negatively affect physical and optical characteristics of glass laminates.

Glass layers have been laminated without a polymer interlayer by heating the glass layers until fusion occurs. Unfortunately, the required temperatures are frequently above about 700 C for common glasses and are even higher for certain specialty glasses. Heating glass to this temperature obviously increases the required energy and the cycle time for heating and cooling the glass laminate. Both factors increase production cost.

Alternatively, all-glass laminates have been made by applying siloxane molecules on the surface of a first glass layer. A second glass layer is placed against the first glass layer. Heating and pressing causes the layers to bond without the use of a polymer interlayer. Presumably, the siloxane condenses thereby bonding the glass layers together. Negatively, the surfaces of the glass layers must be very smooth, siloxanes are relatively expensive, and the glass is still heated to at least about 200 C.

A need exists for a glass laminate that does not require a polymer interlayer and can still be processed quickly with reduced energy consumption. In some instances, it is also desirable to quickly heat the interface between the glass layers with little heating of the bulk glass.

### SUMMARY OF THE INVENTION

The invention is a method for laminating glass, glass-ceramic, or ceramic layers, which comprises:

providing a first layer of glass, glass-ceramic, or ceramic, wherein the glass, glass-ceramic, or ceramic of the first layer is electromagnetic radiation-sensitive or has an electromagnetic radiation susceptor disposed on it;

stacking a second layer of glass, glass-ceramic, or ceramic on the first layer; and

irradiating the stack with electromagnetic radiation to laminate the first and second layers.

By not requiring a polymer interlayer, the laminate can possess improved high temperature performance, optical properties, and strength. Advantageously, the invention can also decrease energy consumption and increase productivity.

### BRIEF DESCRIPTION OF THE DRAWINGS

FIGS. 1A and 1B illustrate two-layer stacks of glass, glass-ceramic, or ceramic layers to be irradiated according to an embodiment of the invention, wherein the layers are stacked horizontally (FIG. 1A) or vertically (FIG. 1B).

FIG. 2 illustrates a two-layer stack of glass layers to be irradiated according to an embodiment of the invention.

FIG. 3 illustrates three-layer stack of glass layers to be irradiated according to an embodiment of the invention.

### DETAILED DESCRIPTION OF THE INVENTION

The invention is a method for laminating glass, glass-ceramic, or ceramic layers, which comprises:

providing a first layer of glass, glass-ceramic, or ceramic, wherein the glass, glass-ceramic, or ceramic of the first layer is electromagnetic radiation-sensitive or has an electromagnetic radiation susceptor disposed on it;

stacking a second layer of glass, glass-ceramic, or ceramic on the first layer; and

irradiating the stack with electromagnetic radiation to laminate the first and second layers.

In one embodiment of the invention, the glass, glass-ceramic, or ceramic of the first layer is electromagnetic radiation-sensitive by virtue of its composition. In this embodiment, the glass, glass-ceramic, or ceramic will absorb the electromagnetic radiation and soften at least at the interface of the layers to form the laminate. Example glass, glass-ceramics, and ceramics that are electromagnetic radiation sensitive include those having a dielectric tan δ of 0.02 or greater during irradiation, for example having a dielectric tan δ of 0.1 or greater, or 1.0 or greater, during irradiation.

The tangent of the dielectric loss angle, tan δ, is equal to the dielectric loss divided by the dielectric constant of a material. Dielectric loss is therefore proportional to tan δ. Electromagnetic radiation-sensitive glass, glass-ceramic, or ceramic will preferably have high dielectric loss across a range of irradiating frequencies. At least a portion of the absorbed energy translates into heat, thereby softening the glass, glass-ceramic, or ceramic of the first layer, the second layer, or both, to cause lamination. Tan δ values for a variety of materials can be found in the literature, for example, in A. R. Von Hippel ed., Dielectric Materials and Applications, John Wiley & Sons, NY (1995).

In one embodiment, the first layer is a glass. Alkali-containing glasses, particularly those with lithium or sodium, as well as glasses with highly polarizable cations or anions, are sensitive to electromagnetic radiation. Mixed-ion glasses are possible but less preferred. Polarizable anions and cations that polarize in an electric field include compounds such as barium titanate, halogen anions, oxygen anions, and metal cations, such as, for example silver, aluminum, magnesium, and rhodium cations. Loosely-structure glasses such as peralkaline glasses and glasses with relatively low levels of alkaline earth cations are also sensitive to electromagnetic radiation.

In another embodiment, the first layer is a glass-ceramic. A glass-ceramic is produced by the controlled devitrification of glass, and may include from 20-98 vol % crystalline phase with the remainder being glass. Glass-ceramics are particularly suitable because of their high strength. A glass-ceramic can offer the advantage of having a highly radiation sensitive crystal phase, such as a nepheline (e.g. sodium aluminosilicate) or rutile (e.g. TiO₂) phase. In yet another embodiment, the first layer is a ceramic. An example ceramic is cordierite.

In addition to being sensitive to electromagnetic radiation, or as an alternative to being sensitive to electromagnetic radiation, the glass, glass-ceramic, or ceramic of the first layer may have an electromagnetic radiation susceptor disposed on it. In this embodiment, the electromagnetic radiation susceptor will absorb the electromagnetic radiation and thereby produce heat to soften or augment the softening of at least one of the layers at the interface of the layers to bond the two layers.

In one embodiment, the glass, glass-ceramic, or ceramic of the first layer is electromagnetic radiation-sensitive and does not have an electromagnetic radiation susceptor disposed on it. In another embodiment, the glass, glass-ceramic, or ceramic of the first layer is not electromagnetic radiation-sensitive but does have an electromagnetic radiation susceptor disposed on it. In another embodiment, the glass, glass-ceramic, or ceramic of the first layer is electromagnetic radiation-sensitive and further has an electromagnetic radiation susceptor disposed on it.

Example electromagnetic radiation susceptors include those having a dielectric tan δ of 0.05 or greater during irradiation, for example having a dielectric tan δ of 0.05 to 100, for instance from 0.05 to 50 or 50 to 100. The radiation susceptor may be, for instance, a continuous or non-continuous layer disposed on a surface of the glass, glass-ceramic, or ceramic of the first layer and contacting the second layer of glass, glass-ceramic, or ceramic in the stack. The suscepting layer may be sprayed, diffused into, ion exchanged or otherwise disposed on the glass, glass-ceramic, or ceramic layer.

Specific examples of radiation susceptors include tin oxide, antimony tin oxide, zinc oxide, carbon nanotubes, alkali or alkaline earth metals, titania, and dielectrics containing conducting metals, semiconductors, and glasses having high concentrations of ionic vacancies. Depending on the application, the susceptor may range from transparent to substantially opaque.

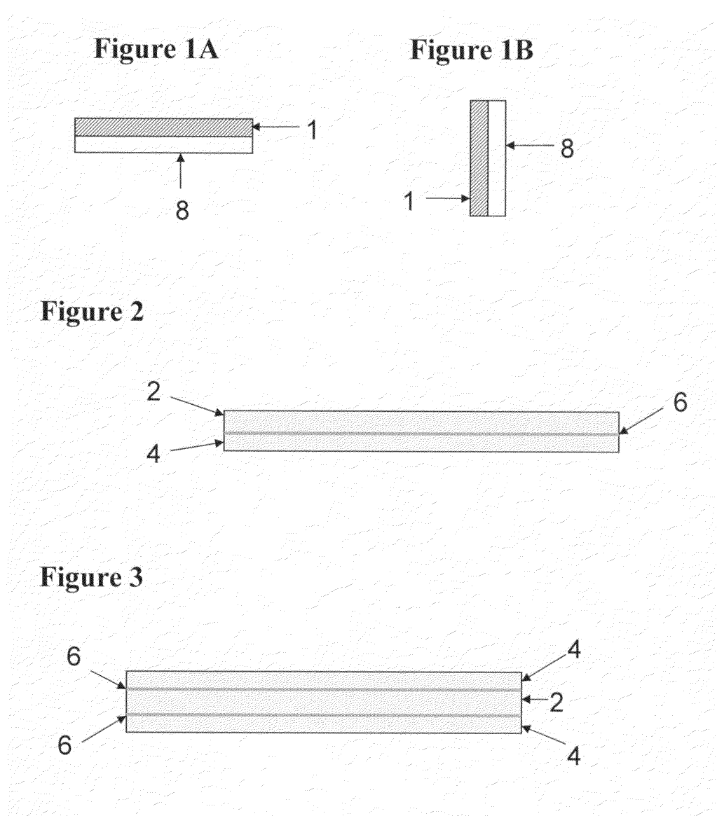

The method of the invention comprises stacking a second layer of glass, glass-ceramic, or ceramic on the first layer. Example glass, glass-ceramics, and ceramics for the second layer include those mentioned above for the first layer. The first layer, the second layer, or both, may be in the form of sheets. Each sheets may have, for instance, a substantially uniform thickness. Stacking the second layer on the first layer comprises bringing the surfaces of the layers in contact with each other in any manner. Stacking therefore including stacking the layers one on top of the other with their surfaces arranged horizontally, as well as stacking the layers beside each other with their surfaces arranged vertically. FIG. 1A illustrates stacking a first layer (1) on a second layer (8), with their surfaces arranged horizontally. FIG. 1B illustrates stacking a first layer (1) on a second layer (8), with their surfaces arranged vertically. Stacking the layers also includes bringing the first layer in contact with a stationary second layer, as well as bringing the second layer in contact with a stationary first layer.

In one embodiment, the second layer of glass, glass-ceramic, or ceramic is electromagnetic radiation-sensitive or has an electromagnetic radiation susceptor disposed on it. Example electromagnetic radiation susceptors include those mentioned above for the first layer. In this embodiment, the glass, glass-ceramic, or ceramic and/or susceptor will absorb the electromagnetic radiation and soften at least the second layer at the interface of the layers to form the laminate. This may occur concurrently with softening of the first layer. In another embodiment, the second layer of glass, glass-ceramic, or ceramic is not electromagnetic radiation-sensitive and does not have an electromagnetic radiation susceptor disposed on it. In this embodiment, only the glass, glass-ceramic or ceramic of the first layer may soften or, the glass, glass-ceramic, or ceramic of the second layer may soften if it absorbs heat from the first layer or susceptor disposed on the first layer.

In one embodiment, the second layer is a glass. In another embodiment, the second layer is a glass-ceramic. In yet another embodiment, the second layer is a ceramic. In some embodiments, both the first and second layers are glass, while in other embodiments both the first and second layers are glass-ceramics, while in other embodiments both the first and second layers are ceramics. In other embodiments, one layer is a glass and the other layer is a glass-ceramic or a ceramic. In yet further embodiments, one layer is a glass-ceramic and the other layer is a glass or ceramic. Thus, the invention is applicable to laminating a wide variety of glass, glass-ceramics, or ceramics, including silica, soda lime, Pyrex, spinel glass-ceramic, beta-quartz glass-ceramic, cordierite glass, LCD-type glasses, sapphire, transparent frits, and glasses with hydrolyzed surfaces such as disclosed in WO 2003/037812.

The method of the invention comprises irradiating the stack of the first and second layers with electromagnetic radiation to laminate the first and second layers. In one embodiment, the stack is irradiated with electromagnetic radiation at a frequency of from 3 MHz to 300 GHz, for example from 20 GHz to 300 GHz, or from 28 GHz to 200 GHz, or from 80 GHz to 200 GHz. The electromagnetic irradiation includes irradiation at microwave and radio frequencies. In one embodiment, the stack is irradiated using a gyrotron. The gyrotron permits more accurate direction of and control over the microwave radiation than conventional microwave sources.

The irradiation of the stack may be directed, for example, only at the interface of the first and second layers. For instance, the energy may be directed as a line that moves from one side of the stack to the other, the energy may be directed as a point or volume that is rastered across the entirely of the surface, the energy may be contained within a cavity or vestibule and be multimode or single mode in nature, or the energy may be focused and directed through a layer to the interface and area between layers. In addition, one embodiment of the invention comprises irradiating the entire volume of the stack.

Optionally, the stack may be pressed and/or evacuated during irradiation. Pressing and evacuating can reduce optical and mechanical defects in the glass laminate. By applying directional pressure, a desirable residual stress profile, for example, tension inside/compression outside, may also be achieved. The irradiation may be conducted for example, upon application of a pressure of at least 13 kPa, for instance of at least 1 MPa, to the stack during irradiation or upon application of a vacuum of less than 250 mmHg, for example less than 100 mm Hg, to the stack during irradiation.

The layered structure may also be optionally heated by conventional techniques before and/or during irradiation to facilitate bonding of the layers, for example, to raise the dielectric tan δ of the glass, glass-ceramic, or ceramic or electromagnetic radiation susceptors to enable more efficient bonding at the time of irradiation. Tan δ often increases with temperature so that mildly heating the layered structure can significantly increase energy absorption. Heating above the softening point of a glass will typically dramatically increase tan δ. Heating and radiating may be accomplished with a hybrid heat source which uses conventional heating technologies to heat the bulk material while applying electromagnetic radiation as needed.

The lamination of the stack may take place within any suitable apparatus. In one embodiment, such an apparatus comprises a furnace, optionally including a vacuum chamber having inlet and outlet vacuum locks, a vacuum pump connected to the chamber for evacuating air therefrom, and a through conveyor for conveying glass sheets from the inlet lock to the outlet lock and for positioning the sheets to be laminated in the chamber for heat treatment. Bonding heat can be provided within the chamber by a device providing controllable distribution of electromagnetic radiation over selected areas of the glass, glass-ceramic, or ceramic stack for bonding sheets together. Incoming and outgoing bridge conveyors can be provided, respectively, for the inlet and outlet vacuum locks for moving sheets into and out of the vacuum chamber.

Additional layers may be laminated to the first or second layers of the laminated stack using the same techniques discussed above. Layers can be bonded sequentially, or multiple layers can be bonded at the same time. The number of layers that can be bonded simultaneously will depend on the irradiation wavelength employed and optical properties of the layered structure, for example, reflection between layers. Both transverse and axially coupled energy can be used to distribute energy through the layers and to facilitate bonding.

The method of the invention provides for direct lamination of the first layer to the second layer, without the use of a polymer inter-layer between the two. The method of the invention may, however, be used to laminate first and second layers together, where one or both have been pre-laminated to other materials on other surfaces through conventional techniques, such as through the use of polymer inter-layer.

### EXAMPLE 1

### Electromagnetic Energy Assisted Bonding of One ITO Susceptor Coated Glass Slide Directly with Another Glass Slide with No Polymer Interlayer

One side of slide glass (4) coated with indium tin oxide (ITO) [manufactured by Delta Technology: CG-901N-S115, polished float glass, 25×75×1.1 mm, SiO₂ passivated and ITO coated, Rs=70-100 ohms, cut edges.] and one conventional glass slide (2): Corning 2947, Micro Slide, 25×75×1.1 mm were stacked together as illustrated in FIG. 2. The ITO film (6) was used as susceptor of electromagnetic energy. The sample assembly was placed inside of grooved fiber board insulator block: Rath KVS 124 board. The top face of the sample was covered by another fiber board insulator block. The fiber board assembly was placed in a microwave oven (Panasonic, NN-T790SAF, multimode, maximum power: 1300 W) at 100% power for different durations of time.

The stack was exposed to 2.45 GHz 1300 W microwave energy in multimode for three different exposure times. In the first case, the sample was exposed to a microwave field for 45 seconds. The glass assembly was not bonded together and cracked during cool down. In the second case, the sample was exposed to a microwave field for 60 seconds. The sample was partially bonded in the middle of the sample (˜25 percent of total surface area) and cracked during cooling. In the third case, the sample was exposed to a microwave field for 90 seconds. The glass assembly was bonded together and the top and bottom surfaces had a texture pattern of insulation. This indicated the sample reached its softening point and there were no cracks. Cracking was reduced by thermal management (slow cooling speed) after this process.

### EXAMPLE 2

### Electromagnetic Energy Assisted Bonding of Glass Slide Sandwiched between Two Glass Slides Coated on One Side with ITO Susceptor and with No Polymer Interlayer

One conventional glass slide (2) was sandwiched between two ITO coated glass slides (4), [manufactured by Delta Technology: CG-901N-S115, polished float glass, 25×75×1.1 mm, SiO₂ passivated and ITO coated, Rs=70-100 ohms, cut edges]. The stack is illustrated in FIG. 3. The ITO films (6) were used as susceptors of electromagnetic energy. The two ITO coated sides faced toward the sandwiched conventional glass slide.

The stack was irradiated with 2.45 GHz 1300 W microwave energy in multimode and exposed for 120 seconds. The glass assembly was bonded together and the top and bottom surfaces had a texture pattern of insulation. This indicated the sample reached its softening point and there was no cracking. Cracking was reduced by thermal management (slow cooling speed) after this process.

### COMPARATIVE EXAMPLE

### Electromagnetic Energy Assisted Bonding of Two Glass Slides with a Polyurethane Interlayer and an ITO Susceptor Coated on One of the Glass Slides

One side of slide glass was coated with indium tin oxide (ITO), manufactured by Delta Technology: CG-611N-S115, polished float glass, 25×75×1.1 mm, SiO₂ passivated and ITO coated, Rs=15-25 ohms, cut edges. This ITO film was used as susceptor of electromagnetic energy. A polyurethane piece, 10×28×0.67 mm thick (Deerfield, A4700), was sandwiched between a conventional glass slide: Corning 2947, Micro Slide, 25×75×1.1 mm, and the slide coated with ITO, with the coated side faced toward the sandwiched polyurethane sheet.

The sample assembly was placed inside of grooved fiber board insulator block: Rath KVS 124 board. The top face of the sample was covered by another fiber board insulator block. The fiber board assembly was placed in a microwave oven (Panasonic, NN-T790SAF, multimode, maximum power: 1300 W) and the sample was exposed at 50% power to 2.45 GHz 650 W microwave energy in multimode and for three different durations of time.

In the first case, the sample was exposed to a microwave field for 20 seconds, stopped for 5 sec., restarted for 20 sec., stopped for another 5 sec., and restarted for 20 sec. The sample had no glass cracks and small bubbles were observed in the perimeter of the polyurethane piece. In the second case, the sample was exposed to a microwave field for 30 seconds, stopped for 5 sec., and restarted for another 30 sec. The sample had two edge cracks and many trapped bubbles. Burning brown color was seen from polyurethane material flowing out from the glass slides. In the third case, the sample was exposed to a microwave field for 60 seconds and the run was stopped. The sample had many edge cracks and many trapped bubbles. Burning brown color was seen from polyurethane material flowing out from the glass slides

Numerous modifications and variations within the present invention are possible. It is, therefore, to be understood that within the scope of the following claims, the invention may be practiced otherwise than as specifically described. While this invention has been described with respect to certain preferred embodiments, different variations, modifications, and additions to the invention will become evident to persons of ordinary skill in the art. All such modifications, variations, and additions are intended to be encompassed within the scope of the claims appended hereto.

We claim:

1. A method for laminating glass, glass-ceramic, or ceramic layers, which comprises:
providing a first layer of glass, glass-ceramic, or ceramic, wherein the glass, glass-ceramic, or ceramic of the first layer is electromagnetic radiation-sensitive or has an electromagnetic radiation susceptor disposed on it;
stacking a second layer of glass, glass-ceramic, or ceramic on the first layer; and
irradiating the stack with electromagnetic radiation to laminate the first and second layers.

2. The method of claim 1, wherein the glass, glass-ceramic, or ceramic of the first layer is electromagnetic radiation-sensitive.

3. The method of claim 2, wherein the glass, glass-ceramic, or ceramic of the first layer has a dielectric tan δ of 0.02 or greater during irradiation.

4. The method of claim 1, wherein the glass, glass-ceramic, or ceramic of the first layer is an alkali-containing glass or peralkaline glass.

5. The method of claim 1, wherein the glass, glass-ceramic, or ceramic of the first layer is a glass-ceramic comprising an electromagnetic radiation-sensitive crystal phase.

6. The method of claim 5, wherein the glass-ceramic comprises a nephaline or rutile phase.

7. The method of claim 1, wherein the glass, glass-ceramic, or ceramic of the first layer has an electromagnetic radiation susceptor disposed on it.

8. The method of claim 7, wherein the susceptor has a dielectric tan δ of 0.05 or greater during irradiation.

9. The method of claim 7, wherein the susceptor is a layer disposed on a surface of the glass, glass-ceramic, or ceramic of the first layer and contacting the second layer of glass, glass-ceramic, or ceramic in the stack.

10. The method of claim 9, wherein the suscepting layer comprises indium tin oxide, antimony tin oxide, zinc oxide, carbon nanotubes, alkali or alkaline earth metals, or titania.

11. The method of claim 1, wherein the glass, glass-ceramic, or ceramic of the first layer is electromagnetic radiation-sensitive and further has an electromagnetic radiation susceptor disposed on it.

12. The method of claim 1, wherein the second layer of glass, glass-ceramic, or ceramic is electromagnetic radiation-sensitive or has an electromagnetic radiation susceptor disposed on it.

13. The method of claim 1, wherein the second layer of glass, glass-ceramic, or ceramic is not electromagnetic radiation-sensitive and does not have an electromagnetic radiation susceptor disposed on it.

14. The method of claim 1, which comprises irradiating the stack with electromagnetic radiation at a frequency of from 3 MHz to 300 GHz.

15. The method of claim 1, which comprises irradiating the stack with a gyrotron at a frequency of from 28 GHz to 200 GHz.

16. The method of claim 1, which comprises irradiating the stack only at the interface of the first and second layers.

17. The method of claim 1, which comprises irradiating the entire volume of the stack.

18. The method of claim 1, which comprises applying a pressure of at least 13 kPa to the stack during irradiation.

19. The method of claim 1, which comprises applying a vacuum of less than 250 mmHg to the stack during irradiation.

20. The method of claim 1, which comprises applying external heat to the stack during irradiation.
